(19) United States
(12) Patent Application Publication
(10) Pub. No.: US 2020/0372586 A1
(43) Pub. Date: Nov. 26, 2020

(54) STORAGE MEDIUM, INFORMATION PROCESSING APPARATUS, AND INFORMATION PROCESSING METHOD

(71) Applicant: FUJITSU LIMITED, Kawasaki-shi (JP)

(72) Inventors: Kosuke MIYAHARA, Yokohama (JP); Yusuke Ejiri, Kawasaki (JP); Hiromichi Sasaki, Bunkyou (JP); Eiji Ikeda, Yokohama (JP)

(73) Assignee: FUJITSU LIMITED, Kawasaki-shi (JP)

(21) Appl. No.: 16/876,177

(22) Filed: May 18, 2020

(30) Foreign Application Priority Data
May 23, 2019 (JP) 2019-097125

(51) Int. Cl. G06Q 50/00; G06Q 30/02

(52) U.S. Cl. CPC G06Q 50/01; G06Q 30/0239

(57) ABSTRACT

A non-transitory computer-readable storage medium storing a program that causes a processor included in an information processing apparatus to execute a process, the process includes storing answer information that is information regarding an answer to a question, and identification information for identifying a user who is permitted to use the answer information, in a case where use of the answer information is requested, determining whether or not identification information of a user who is a requestor is stored, and in a case where the identification information of the user who is the requestor is stored, transmitting the answer information to the requestor.

### CROSS-REFERENCE TO RELATED APPLICATION

This application is based upon and claims the benefit of priority of the prior Japanese Patent Application No. 2019-97125, filed on May 23, 2019, the entire contents of which are incorporated herein by reference.

### FIELD

The embodiments discussed herein are related to a storage medium, an information processing apparatus, and an information processing method.

### BACKGROUND

Conventionally, for example, answers to questionnaires, which include personal information, are held by a company that has conducted the questionnaires and are rarely shared with other companies. Furthermore, in acquiring personal information through questionnaires, the personal information is not usable for purposes different from the purpose of use in the absence of permission by respondents themselves. Moreover, personal information is not provided to third parties without permission of respondents themselves.

Furthermore, even in a case of not acquiring personal information, respondents answer a questionnaire after explanation is given about methods of handling and disclosing answers such as not disclosing content that can identify individuals and the respondents themselves give permission.

For example, Japanese Laid-open Patent Publication No, 2000-29830, Japanese Laid-open Patent Publication No. 2006-344156, Japanese Laid-open Patent Publication No. 2004-192353, Japanese Laid-open Patent Publication No. 2002-24477, and the like are disclosed as related art.

### SUMMARY

According to an aspect of the embodiments, a non-transitory computer-readable storage medium storing a program that causes a processor included in an information processing apparatus to execute a process, the process includes storing answer information that is information regarding an answer to a question, and identification information for identifying a user who is permitted to use the answer information, in a case where use of the answer information is requested, determining whether or not identification information of a user who is a requestor is stored, and in a case where the identification information of the user who is the requestor is stored, transmitting the answer information to the requestor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an answer sharing system according to the present embodiment;

FIG. 2 is a block diagram illustrating an example of configuration of the answer sharing system;

FIG. 3 is a block diagram illustrating an example of a hardware configuration of a user terminal device;

FIG. 4 is a block diagram illustrating an example of a hardware configuration of a first company terminal device;

FIG. 5 is a block diagram illustrating an example of a hardware configuration of a second company terminal device;

FIG. 6 is a block diagram illustrating an example of a hardware configuration of a server device;

FIG. 7 is a block diagram illustrating an example of functional configuration of the server device;

FIG. 8 is an explanatory diagram illustrating an example of a personal DB;

FIG. 9 is an explanatory diagram illustrating an example of a credit information DB;

FIG. 10 is an explanatory diagram illustrating an example a company DB;

FIG. 11 is an explanatory diagram illustrating an example of a questionnaire DB;

FIG. 12 is an explanatory diagram illustrating an example of an answer DB;

FIG. 13 is a sequence diagram illustrating an example of processing operations of the user terminal device, the server device, and the first company terminal device regarding questionnaire processing;

FIG. 14 is an explanatory diagram illustrating an example of a questionnaire screen of the user terminal device;

FIG. 15 is an explanatory diagram illustrating an example a permission request screen of the user terminal device;

FIG. 16 is a sequence diagram illustrating an example of processing operations of the user terminal device, the server device, and the second company terminal device regarding first answer request processing;

FIG. 17 is an explanatory diagram illustrating an example of a questionnaire summary screen of the second company terminal device;

FIG. 18 is an explanatory diagram illustrating an example of an answer request screen of the second company terminal device;

FIGS. 19A and 19B are sequence diagrams illustrating an example of processing operations of the user terminal device, the server device, and the second company terminal device regarding second answer request processing;

FIG. 20 is a flowchart illustrating an example of a processing operation of the user terminal device regarding permission request answering processing;

FIG. 21 is an explanatory diagram illustrating an example of a notification screen and a permission request screen of the second company terminal device;

FIG. 22 is an explanatory diagram illustrating an example of change transition of permission for each respondent; and

FIG. 23 is an explanatory diagram illustrating an example of an information processing apparatus that executes an information processing program.

### DESCRIPTION OF EMBODIMENTS

In a case where a third party other than a company that has conducted a questionnaire wants to obtain answers to a questionnaire for the same purpose, the third party conducts the questionnaire with the same content again. As a result, the burden on respondents as well as the burden on the company that conducts the questionnaire increases.

One aspect of the embodiments is to provide an information processing program and the like that can reduce the burden of obtaining an answer.

As one aspect, the burden of obtaining an answer can be reduced.

Hereinafter, the embodiments of an information processing program and the like disclosed in the present application will be described in detail on the basis of the drawings. Note that these embodiments do not limit the disclosed technology. Furthermore, each embodiment to be described below may also be combined as appropriate, without causing inconsistency.

### Embodiment

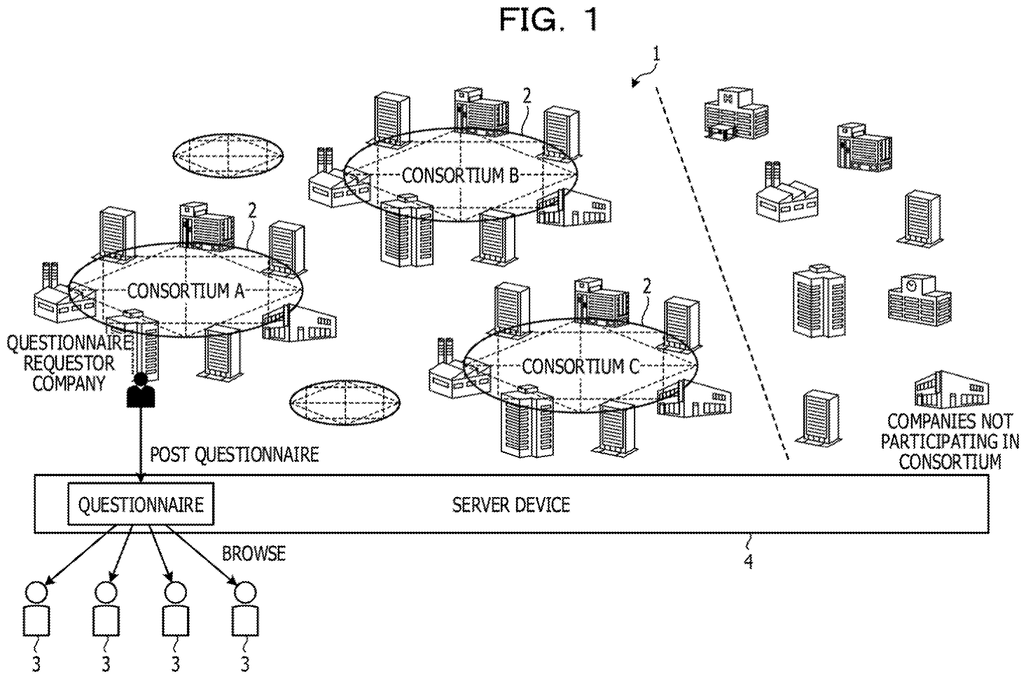

FIG. 1 is an explanatory diagram illustrating an example of an answer sharing system 1 according to the present embodiment. The answer sharing system 1 illustrated in FIG. 1 includes a plurality of consortia 2, a user terminal device 3, and a server device 4. The consortium 2 is, for example, an alliance of a plurality of participating companies having a common activity purpose. The user terminal device 3 is, for example, a mobile terminal of a general user such as a smartphone, or a terminal device such as a personal computer terminal or a tablet terminal. The server device 4 enables communication between a company terminal device 5 and the user terminal device 3 in the consortium 2, and manages various types of information such as questionnaires and answers to the questionnaires, for example.

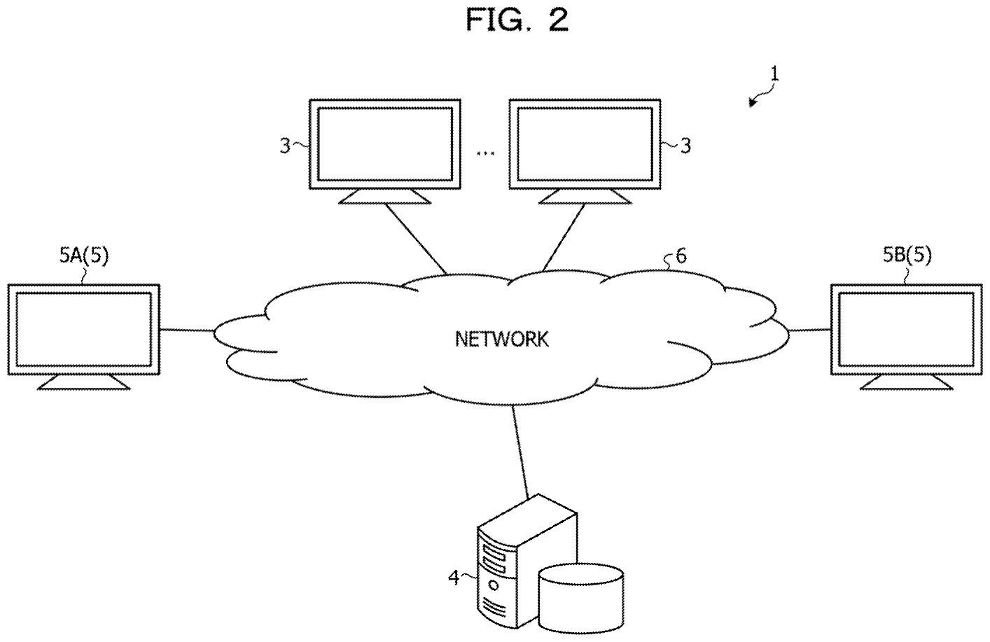

FIG. 2 is a block diagram illustrating an example of a configuration of the answer sharing system 1. The answer sharing system 1 illustrated in FIG. 2 includes the user terminal device 3, a first company terminal device 5A, a second company terminal device 5B, the server device 4, and a network 6. The first company terminal device 5A and the second company terminal device 5B are terminal devices of companies in the consortium 2. Note that the first company terminal device 5A and the second company terminal device 5B are, for example, mobile terminals such as smartphones, or terminal devices such as personal computer terminals or tablet terminals. It is assumed that the first company terminal device 5A is, for example, a terminal device of a requester company that has first requested a questionnaire, and the user terminal device 3 is a terminal device of a respondent who has answered the questionnaire. Furthermore, it is assumed that the second company terminal device 5B is, for example, a terminal device of a company that uses only answers to a questionnaire that has been conducted by another company without conducting the questionnaire. The network 6 is a communication network for connecting the user terminal device 3, the first company terminal device 5A, the second company terminal device 5B, and the server device 4.

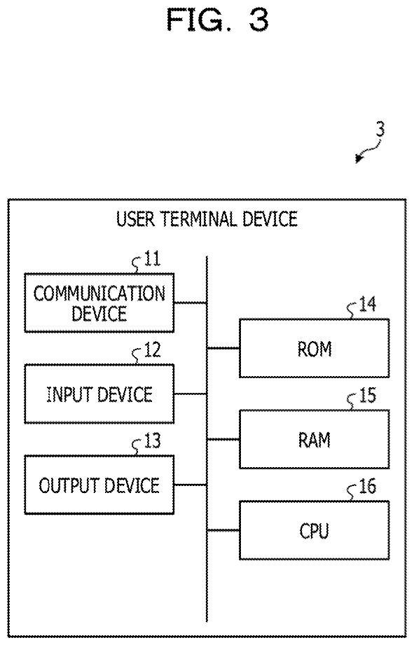

FIG. 3 is a block diagram illustrating an example of a hardware configuration of the user terminal device 3. The user terminal device 3 illustrated in FIG. 3 includes a communication device 11, an input device 12, an output device 13, a read only memory (ROM) 14, a random access memory (RAM) 15, and a central processing unit (CPU) 16. The communication device 11 is a communication interface for communicating with the network 6. The input device 12 is, for example, an input interface for inputting various types of information of an operation unit and the like. The output device 13 is, for example, an output interface that outputs various types of information of a display unit and the like. The ROM 14 stores various programs and the like. The RAM 15 stores various types of information and the like. The CPU 16 controls the entire user terminal device 3.

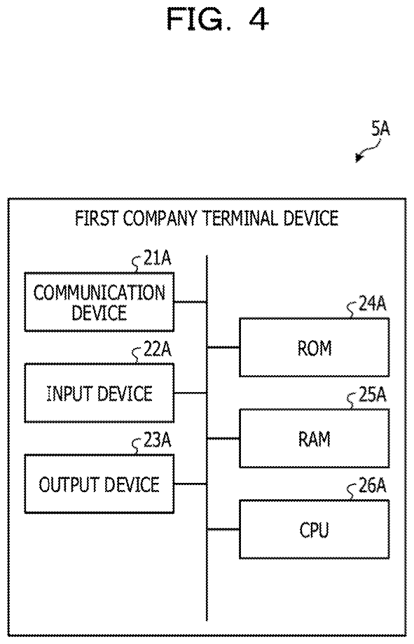

FIG. 4 is a block diagram illustrating an example of a hardware configuration of the first company terminal device 5A. The first company terminal device 5A illustrated in FIG. 4 has a communication device 21A, an input device 22A, an output device 23A, a ROM 24A, a RAM 25A, and a CPU 26A. The communication device 21A is a communication interface for communicating with the network 6. The input device 22A is, for example, an input interface for inputting various types of information of an operation unit and the like. The output device 23A is, for example, an output interface for outputting various types of information of a display unit and the like. The ROM 24A stores various programs and the like. The RAM 25A stores various information and the like. The CPU 26A controls the entire first company terminal device 5A.

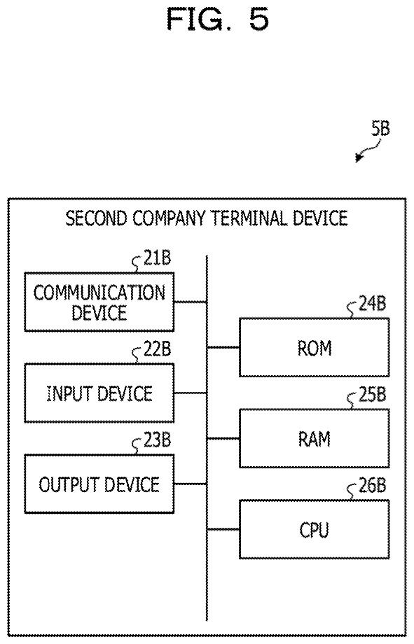

FIG. 5 is a block diagram illustrating an example of a hardware configuration of the second company terminal device 5B. The second company terminal device 5B illustrated in FIG. 5 includes a communication device 21B, an input device 22B, an output device 23B, a ROM 24B, a RAM 25B, and a CPU 26B. The communication device 21B is a communication interface for communicating with the network 6. The input device 22B is, for example, an input interface for inputting various types of information of an operation unit and the like. The output device 23B is, for example, an output interface that outputs various types of information of a display unit and the like. The ROM 24B stores various programs and the like. The RAM 25B stores various types of information and the like. The CPU 26B controls the entire second company terminal device 5B.

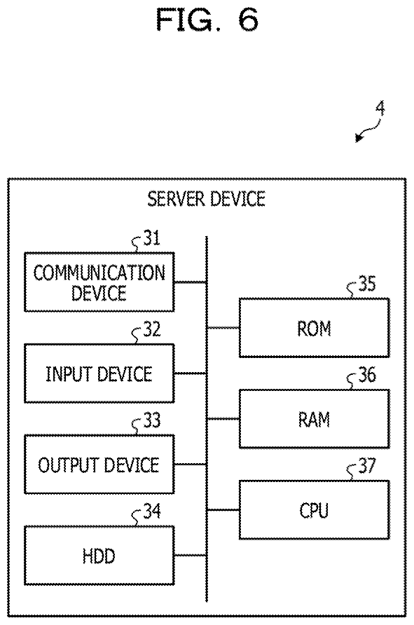

FIG. 6 is a block diagram illustrating an example of a hardware configuration of the server device 4. The server device 4 illustrated in FIG. 6 includes a communication device 31, an input device 32, an output device 33, a hard disc drive (HDD) 34, a ROM 35, a RAM 36, and a CPU 37. The communication device 31 is a communication interface for communicating with the network 6. The input device 32 is, for example, an input interface for inputting various types of information of an operation unit and the like. The output device 33 is, for example, an output interface that outputs various types of information of a display unit and the like. The HDD 34 stores various types of information. The ROM 35B stores various programs and the like. The RAM 36 stores various types of information and the like. The CPU 37 controls the entire server device 4. The CPU 37 expands various programs stored in the ROM 35 on the RAM 36 and executes functions.

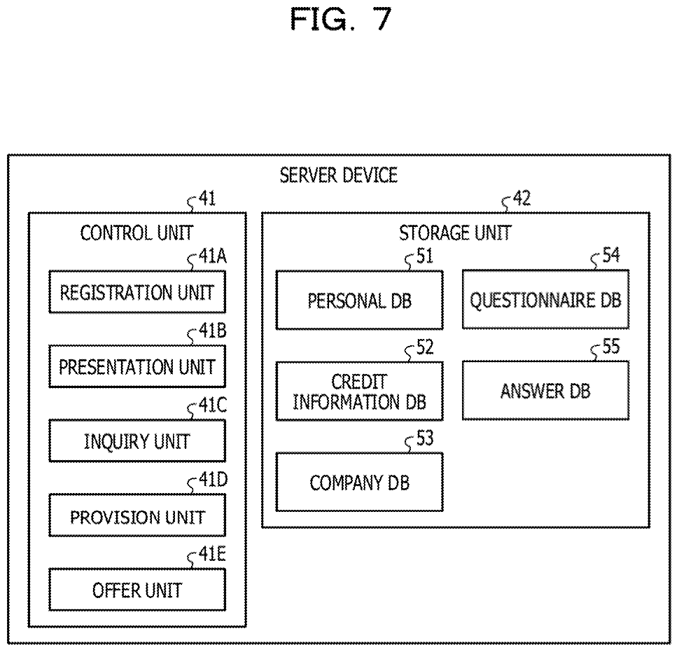

FIG. 7 is a block diagram illustrating an example of a functional configuration of the server device 4. The server device 4 illustrated in FIG. 7 includes a control unit 41 and a storage unit 42. The control unit 41 includes a registration unit 41A, a presentation unit 41B, an inquiry unit 41C, a provision unit 41D, and an offer unit 41E. The control unit 41 controls the entire server device 4. The storage unit 42 stores various types of information. The registration unit 41A registers content of a questionnaire in response to, for example, a questionnaire registration operation from the first company terminal device 5A. Furthermore, in a case where a user (possible user candidate) who can use an answer is specified (permitted) by a respondent, the registration unit 41A stores, in an answer DB 55, the user (possible user candidate) as a use permission range for each answer.

The presentation unit 41B presents various types of information to the user terminal device 3, the first company terminal device 5A, and the second company terminal device 5B. As a result, the user terminal device 3, the first company terminal device 5A, and the second company terminal device 5B display various types of information according to presentation of the various types of information from the presentation unit 41B. In requesting user permission for an answer to a questionnaire, for example, the presentation unit 41B presents a use consideration from the user (second company terminal device 5B) to the respondent (user terminal device 3) for use of the answer and credit information of the user to the user terminal device 3 as the respondent. In a case where the user is specified as a user who is permitted to use the answer by the user terminal device 3 as the respondent, the registration unit 41A registers the user ID for each answer in the answer DB 55. In a case where use of the answer is requested by the second company terminal device 5B as the user, the inquiry unit 41C determines whether or not the user ID of the answer requested to use is in the answer DB 55, that is, whether or not the user ID is in a use permission range 55E in the answer DB 55.

In a case where the user ID of the answer requested to use is in the answer DB 55 on the basis of an inquiry result of the inquiry unit 41C, the provision unit 41D provides the answer to the second company terminal device 5B as the user of the answer requested to use. In the case where the user ID of the answer requested to use is in the answer DB 55 on the basis of the inquiry result, the offer unit 41E offers a use consideration for the answer to the user terminal device 3 as the respondent of the answer requested to use.

The storage unit 42 includes a personal database (DB) 51, a credit information DB 52, a company DB 53, a questionnaire DB 54, and the answer DB 55. The personal DB 51 is a DB that manages personal information. The credit information DB 52 is a DB that manages credit information and the like of the consortium 2. The company DB 53 is a DB that manages information of companies in the consortium 2. The questionnaire DB 54 is a DB for managing contents of questionnaire. The answer DB 55 is a DB that manages individual answers for each questionnaire.

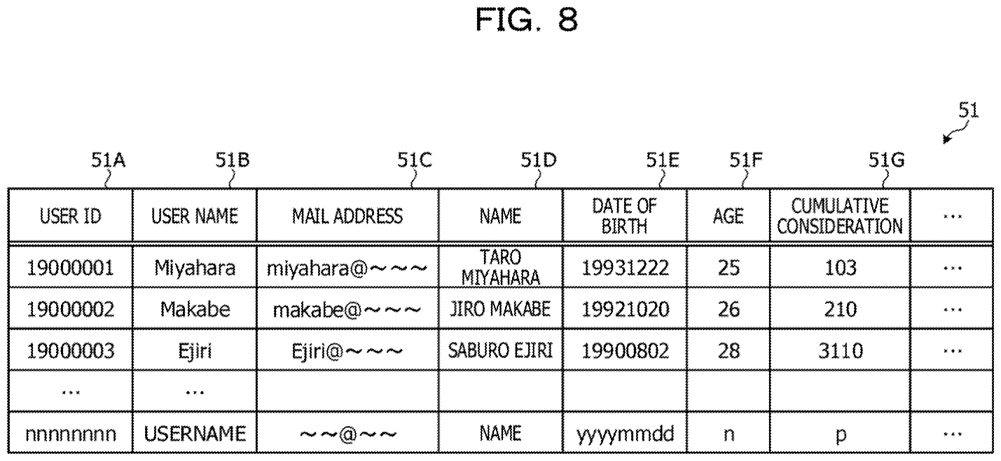

FIG. 8 is an explanatory diagram illustrating an example of the personal DB 51. The personal DB 51 illustrated in FIG. 8 manages personal information. The personal information is information for managing a user ID 51A, a user name 51B, a mail address 51C, a name 51D, a date of birth 51E, an age 51F, and a cumulative consideration 51G in association with one another. The user ID 51A is an ID for identifying a user of the user terminal device 3. The user name 51B is a name for identifying the user of the user terminal device 3. The mail address 51C is an e-mail address of the user terminal device 3. The name 51D is a name for identifying the user of the user terminal device 3. The date of birth 51E is a date of birth of the user of the user terminal device 3. The age 51F is an age of the user of the user terminal device 3. The cumulative consideration 51G is a point owned by the user of the user terminal device 3. Note that the owned point is a point given when permitting use of an answer to the consortium 2, a company, or the like, for example.

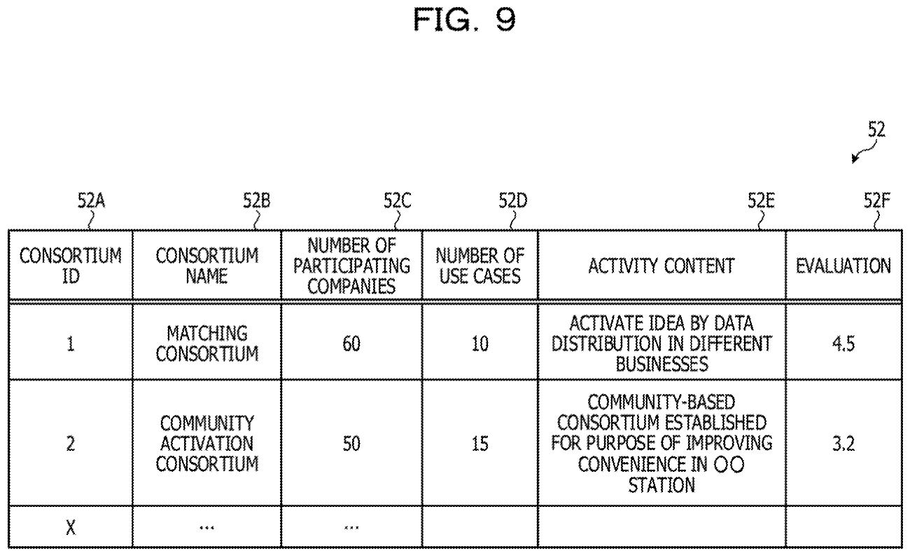

FIG. 9 is an explanatory diagram illustrating an example of the credit information DB 52. The credit information DB 52 illustrated in FIG. 9 manages credit information. The credit information is information for managing a consortium ID 52A, a consortium name 52B, the number of participating companies 52C, the number of use cases 52D, activity content 52E, and an evaluation 52F in association with one another. The consortium ID 52A is an ID for identifying the consortium 2. The consortium name 52B is a name for identifying the consortium 2. The number of participating companies 52C is the number of companies participating in the consortium 2. The number of use cases 52D is the number of use cases in the questionnaires conducted in the consortium 2. The activity content 52E is activity content of the consortium 2. The evaluation 52F is information reflecting the degree of credit of the consortium 2.

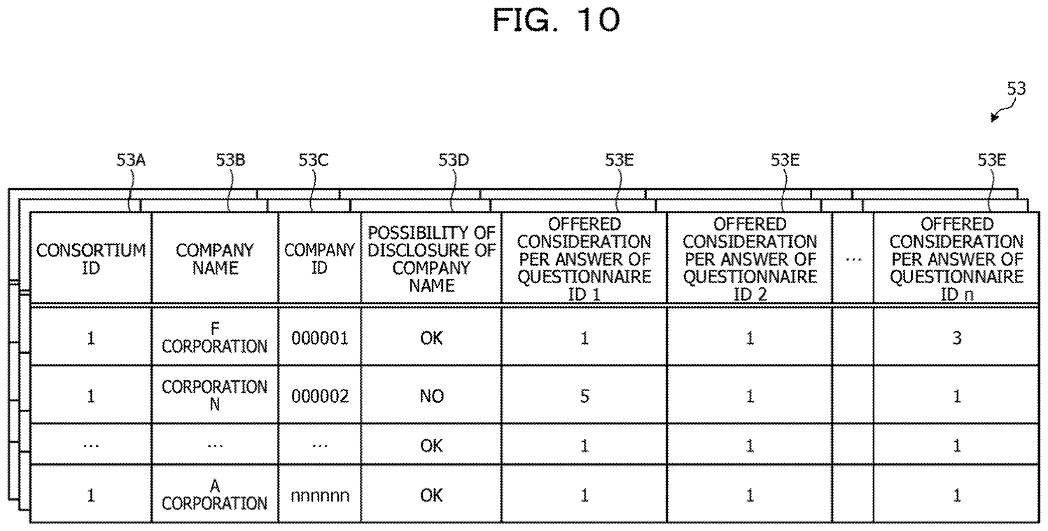

FIG. 10 is an explanatory diagram illustrating an example of the company DB 53. The company DB 53 illustrated in FIG. 10 manages company information of participating companies for each consortium 2. The company information is information for managing a consortium ID 53A, a company name 53B, a company ID 53C, a company name disclosure possibility 53D, and an offer consideration 53E for each questionnaire ID in association with one another. The consortium ID 53A is an ID for identifying the consortium 2 in which the company participates. The company name 53B is a name for identifying the company. The company ID 53C is an ID for identifying the company. The company name disclosure possibility 53D is information for identifying a disclosure possibility of the company name. The offer consideration 53E for each questionnaire ID is a consideration point to be offered to the respondent when the respondent permits use of an answer.

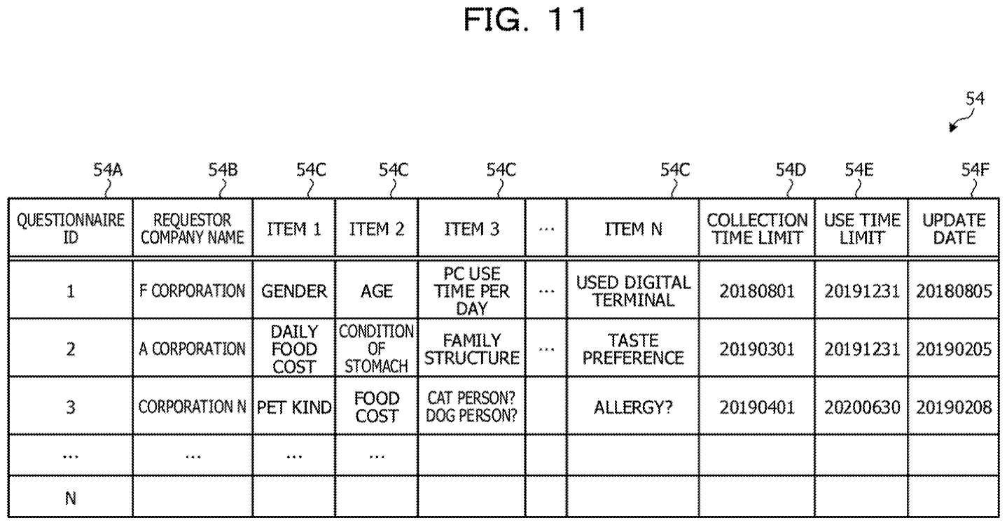

FIG. 11 is an explanatory diagram illustrating an example of the questionnaire DB 54. The questionnaire DB 54 illustrated in FIG. 11 manages questionnaire information for each questionnaire. The questionnaire information is information for managing a questionnaire ID 54A, a requestor company name 54B, a questionnaire item 54C, a collection time limit 54D, a use time limit 54E, and an update date 54F in association with one another. The questionnaire ID 54A is an ID for identifying the questionnaire. The requestor company name 54B is a name for identifying the company that has requested the questionnaire. The questionnaire item 54C is content of a question in the questionnaire. Note that the questionnaire item 51C may be a plurality of items. The collection time limit 54D is a time limit for collecting answers to the questionnaire. The use time limit 54E is a time limit till when the answer to the questionnaire can be used. The update date 54F is a date when the questionnaire information was last updated.

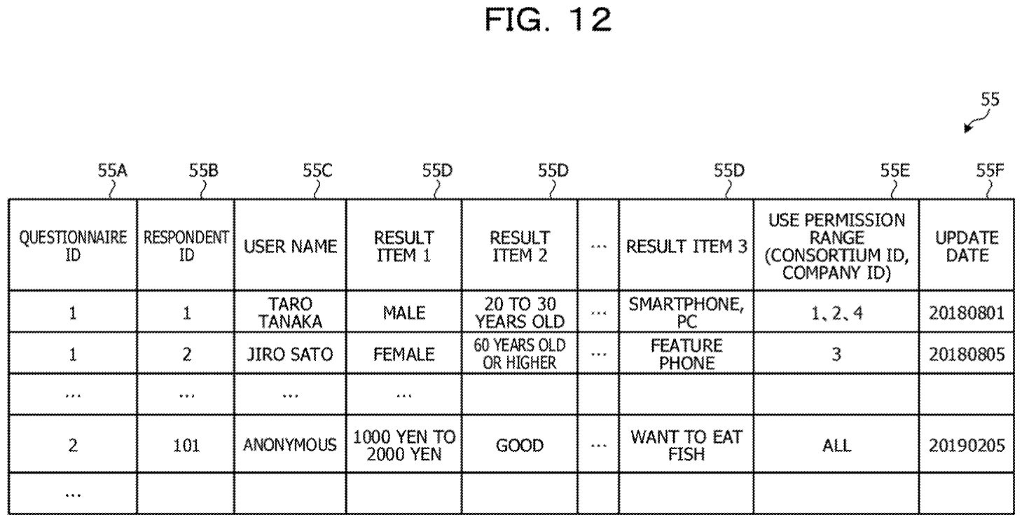

FIG. 12 is an explanatory diagram illustrating an example of the answer DB 55. The answer DB 55 illustrated in FIG. 12 manages answer information for each questionnaire. The answer information is information for managing a questionnaire ID 55A, a respondent ID 55B, a user name 55C, a result item 55D, the use permission range 55E, and an update date 55F in association with one another. The questionnaire ID 55A is an ID for identifying the questionnaire. The respondent ID 55B is an ID for identifying the respondent to the questionnaire. The user name 55C is a name for identifying the respondent. The result item 55D is an answer according to a questionnaire item. The use permission range 55E is an ID for identifying a possible user company or consortia 2 who can use the answer. The update date 55F is a date when the answer information was last updated.

The server device 4 generates credit information from the information of the consortium 2 in the credit information DB 52, the use permission range in the answer DB 55, and the company information in the company DB 53. The server device 4 presents a permission request screen including the credit information, which will be described below, to the user terminal device 3 as the respondent. The respondent of the user terminal device 3 can determine whether or not to permit use of an answer to the consortium 2 or the company by viewing the credit information on the permission request screen.

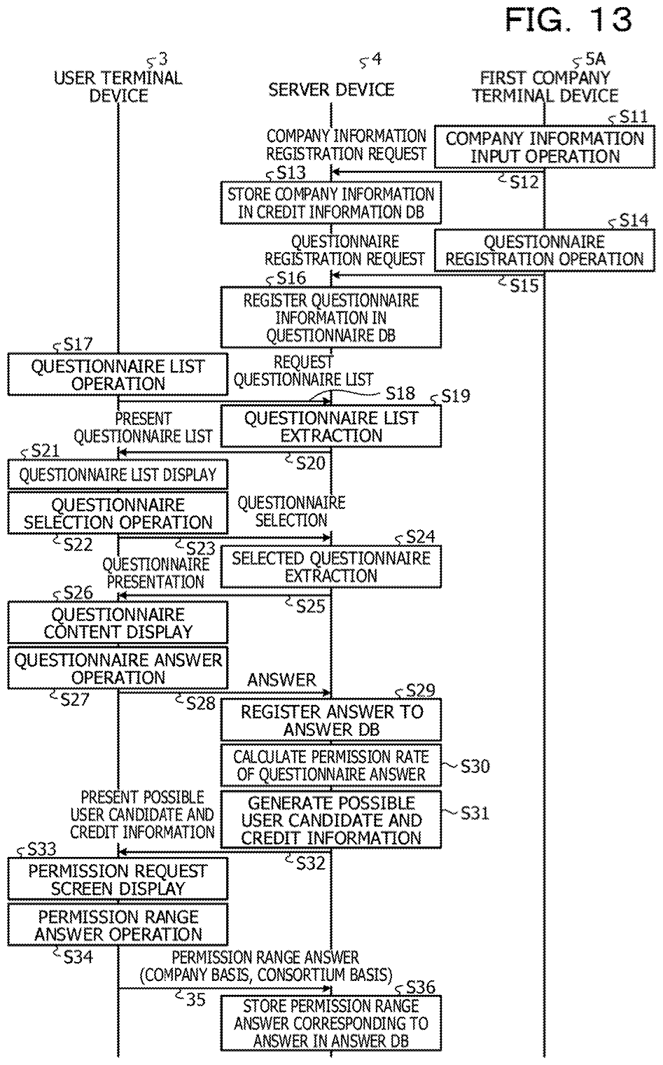

Next, an operation of the answer sharing system 1 of the present embodiment will be described. FIG. 13 is a sequence diagram illustrating an example of processing operations of the user terminal device 3, the server device 4, and the first company terminal device 5A regarding questionnaire processing. Note that the first company terminal device 5A is a terminal device that requests the server device 4 to conduct a questionnaire.

In a case of detecting an input operation for inputting company information (step S11), the first company terminal device 5A transmits a company information registration request to the server device 4 (step S12). In a case of detecting the company information registration request, the server device 4 registers the company information in the company DB 53 and the credit information DB 52 (step S13).

In a case of detecting a registration operation for registering questionnaire information (step S14), the first company terminal device 5A transmits a questionnaire information registration request to the server device 4 (step S15). In a case of detecting the questionnaire information registration request, the server device 4 registers the questionnaire information in the questionnaire DB 54 (step S16).

In a case of detecting a questionnaire list operation (step S17), the user terminal device 3 transmits a questionnaire list request to the server device 4 (step S18). In a case of detecting the list request, the server device 4 extracts a questionnaire list from the questionnaire DB 54 (step S19), and presents the questionnaire list to the user terminal device 3 (step S20). In a case of detecting the presentation of the questionnaire list, the user terminal device 3 displays the questionnaire list (step S21). In a case of detecting a questionnaire selection operation during display of the questionnaire list (step S22), the user terminal device 3 transmits a questionnaire selection request to the server device 4 (step S23).

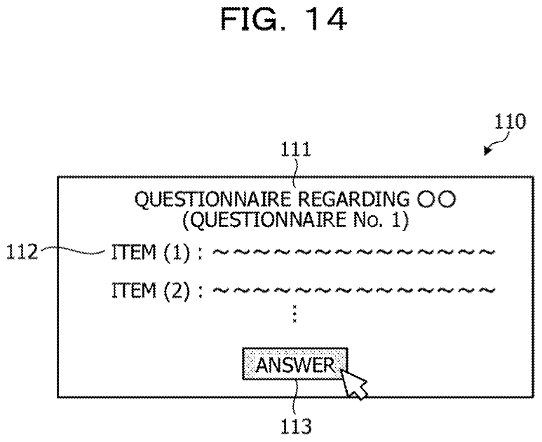

In a case of detecting the questionnaire selection request, the server device 4 extracts questionnaire information of the selection request from the questionnaire DB 54 (step S24). The server device 4 presents the extracted questionnaire information to the user terminal device 3 (step S25). In a case where the questionnaire information is presented, the user terminal device 3 displays questionnaire content (questionnaire screen) (step S26). FIG. 14 is an explanatory diagram illustrating an example of a questionnaire screen 110 of the user terminal device 3. The questionnaire screen 110 illustrated in FIG. 14 includes, for example, a questionnaire name 111, a questionnaire item 112, and an answer button 113. The answer button 113 is a button for starting an answer operation.

In a case of detecting the questionnaire answer operation during display of the questionnaire screen 110 (step S27), the user terminal device 3 transmits an answer to the server device 4 (step S28). In a case of receiving answer from each user terminal device 3, the server device 4 registers the answer to the answer DB 55 (step S29).

The server device 4 calculates a current permission rate from the answers (step S30). Note that the server device 4 calculates an answer permission rate using a ratio of the total number of permitted usable answers to the total number of answer respondents. The server device 4 generates possible user candidates regarding an answer and credit information of the possible users (step S31) and presents the possible user candidates and the credit information of the possible users to the user terminal device 3 (step S32). The possible user candidate is a company candidate that is not permitted to use the answer. The credit information of the possible user is credit information of the company that is not permitted to use the answer.

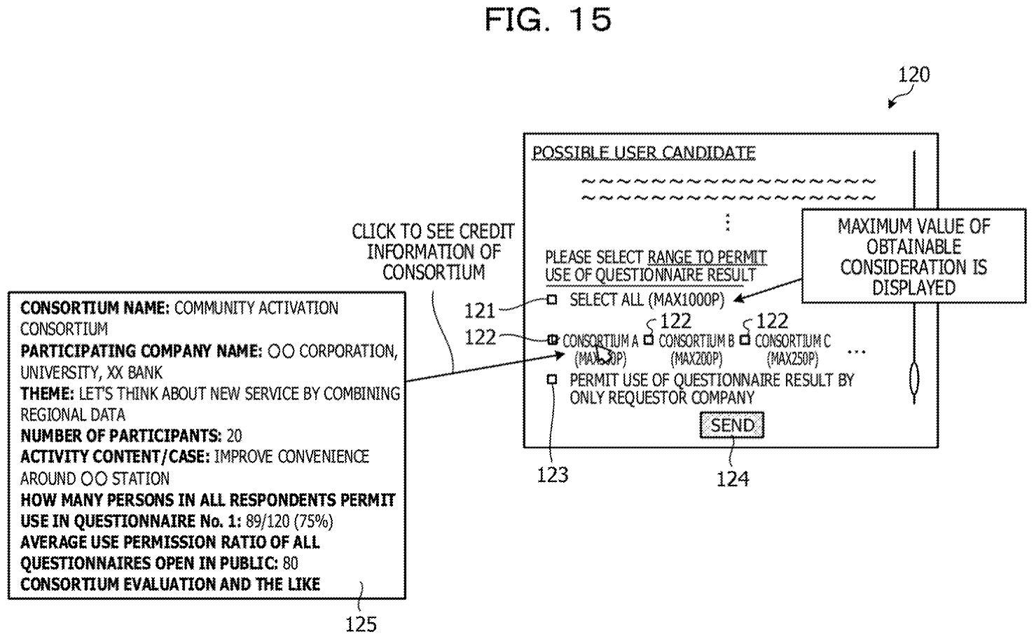

After the possible user candidates and the credit information of the possible users are presented, the user terminal device 3 displays the permission request screen including the possible user candidates and the credit information of the possible users (step S33). FIG. 15 is an explanatory diagram illustrating an example of the permission request screen 120 of the user terminal device 3. The permission request screen 120 illustrated in FIG. 15 includes an all permission checkbox 121, a specified permission checkbox 122, a requestor company permission checkbox 123, a send button 124, and credit information 125. The ail permission checkbox 121 is a checkbox for permitting use of an answer to all the companies of all the consortia 2. Furthermore, a consideration to be offered in a case of permitting use of the answer to all the companies of all the consortia 2 is displayed near the all permission checkbox 121. The specified permission checkbox 122 is a checkbox for permitting use of the answer to only a specified consortium 2. A consideration to be offered in a case of permitting use of the answer to the companies of the specified consortium 2 is displayed near the specified permission checkbox 122. The requestor company permission checkbox 123 is a checkbox for permitting use of the answer to only the requestor company. A consideration to be offered in a case of permitting use of the answer to the requester company is displayed near the requester company permission checkbox 123. The send button 124 is a button for sending permission content to the server device 4. The credit information 125 is credit information of the specified consortium 2 that is displayed in a popup when the specified consortium 2 on the screen is clicked. The credit information 125 includes an activity purpose of the consortium 2, participating company names, the number of participating companies, a permission ratio for conducting questionnaires, and the like. For example, the participating company names can be a material for demonstrating the transparency of the consortium 2.

After displaying the permission request screen 120, the user terminal device 3 detects an answer operation in a permission range for specifying a company or a consortium (step S34). Note that the answer operation in the permission range can specify a range in which the answer can be used, by specifying the all permission checkbox 121, the specified permission checkbox 122, or the requester company permission checkbox 123, for example.

In a case of detecting the answer operation in the permission range, the user terminal device 3 transmits the answer and the permission range to the server device 4 (step S35). In a case of detecting the answer and the permission range, the server device 4 registers the answer and the permission range in the answer DB 55 (step S36) and terminates the processing operation illustrated in FIG. 13.

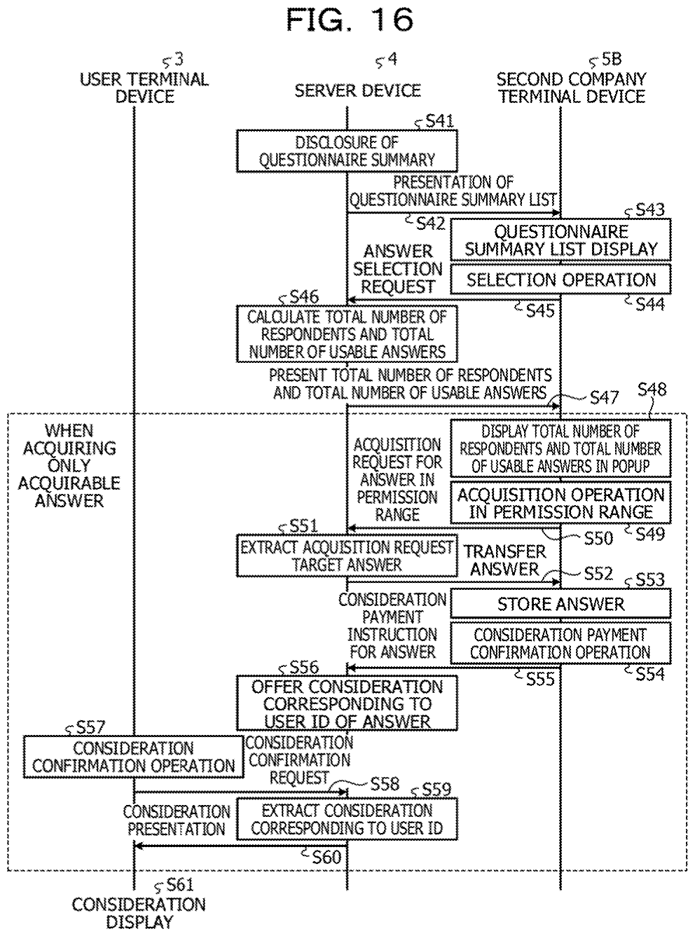

FIG. 16 is a sequence diagram illustrating an example of processing operations of the user terminal device 3, the server device 4, and the second company terminal device 5B regarding first answer request processing. The second company terminal device 5B is a terminal device of a company that uses the answer to the questionnaire requested by the first company terminal device 5A.

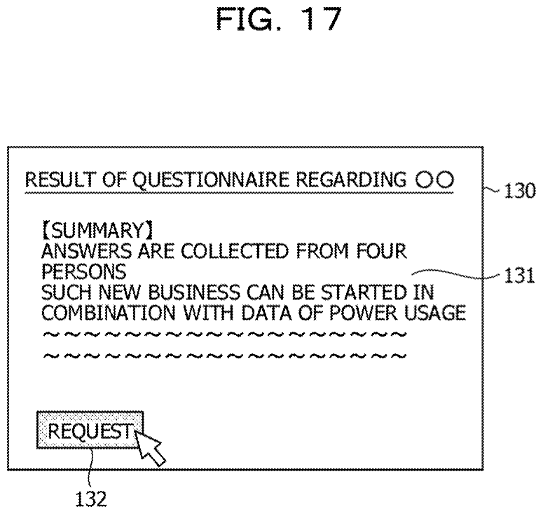

The server device 4 discloses a questionnaire summary (step S41). The server device 4 presents a list of questionnaire summaries to the second company terminal device 5B (step S42). The second company terminal device 5B displays a list screen for the questionnaire summaries (step S43). Note that the user of the second company terminal device 5B can recognize the summary of each conducted questionnaire by viewing the list screen. FIG. 17 is an explanatory diagram illustrating an example of a questionnaire summary screen 130 of the second company terminal device 5B. The questionnaire summary screen 130 illustrated in FIG. 17 includes a questionnaire summary 131 and a request button 132. The questionnaire summary 131 is information indicating a summary of a questionnaire. The request button 132 is a selection operation button for selecting a questionnaire of which an answer is desired. When detecting the selection operation during display of the questionnaire summary list screen (step S44), the second company terminal device 5B transmits an answer selection request of the selected questionnaire to the server device 4 (step S45).

In a case of detecting the answer selection request, the server device 4 calculates the total number of answer respondents and the total number of permitted usable answers (step S46). Note that the server device 4 calculates the total number of answer respondents from the answer DB 55, and the total number of permitted usable answers to the total number of answer respondents. The server device 4 presents the total number of answer respondents and the total number of permitted usable answers to the second company terminal device 5B (step S47). The second company terminal device 5B displays the total number of respondents and the total number of usable answers in a popup (step S48) and detects an acquisition operation within the permission range (step S49).

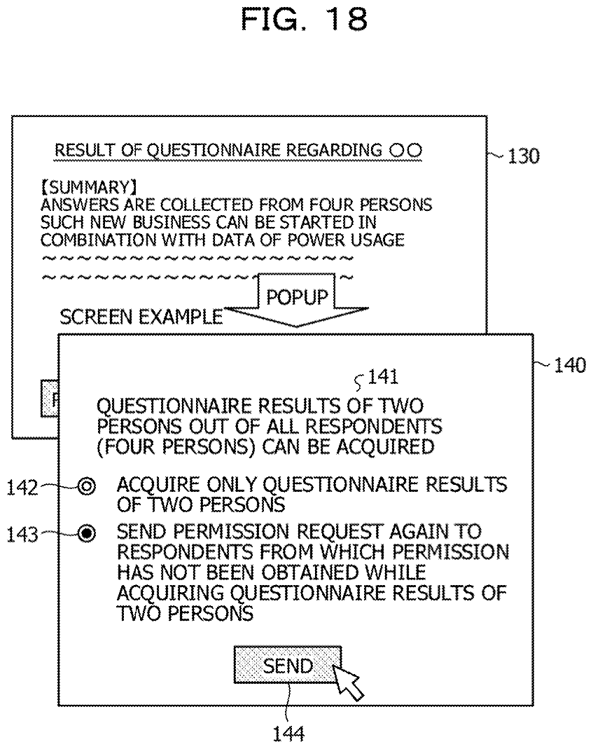

FIG. 18 is an explanatory diagram illustrating an example of an answer request screen 140 of the second company terminal device 5B. The answer request screen 140 includes the total number of respondents and the total number of usable respondents 141, a permission range acquisition checkbox 142, a permission request checkbox 143, and a send button 144. The total number of respondents is a total number of respondents. The total number of usable respondents is a total number of respondents who have permitted use of an answer. The permission range acquisition checkbox 142 is a checkbox for requesting acquisition of an answer of a respondent who has permitted use of the answer. The permission request checkbox 143 is a checkbox for requesting use permission of a respondent who has not permitted use of the answer. The send button 144 is a button for requesting the server device 4 to send check content of the permission range acquisition checkbox 142 or the permission request checkbox 143. Note that the acquisition operation within the permission range is, for example, an operation to check the permission range acquisition checkbox 142 and operates the send button 144.

In a case of detecting the acquisition operation within the permission range, the second company terminal device 5B transmits an acquisition request for an answer in the permission range to the server device 4 (step S50). In a case of detecting the acquisition request for an answer in the permission range, the server device 4 extracts an answer to be acquired from the answer DB 55 (step S51).

The server device 4 transfers the answer extracted from the answer DB 55 to the second company terminal device 5B (step S52). Moreover, the second company terminal device 5B stores the transferred answer (step S53). In a case of detecting a confirmation operation for a consideration payment instruction for the answer (step S54), the second company terminal device 5B transmits the consideration payment instruction for the answer to the server device 4 (step S55). In a case of detecting the consideration payment instruction, the server device 4 offers and updates the consideration corresponding to the user ID of the answer in the personal DB 51 (step S56).

In a case of detecting a consideration confirmation operation (step 557), the user terminal device 3 transmits a consideration confirmation request to the server device 4 (step S58). In a case of detecting the consideration confirmation request, the server device 4 extracts a consideration corresponding to the user ID of the confirmation request from the personal DB 51 (step S59). The server device 4 presents the extracted consideration corresponding to the user ID to the user terminal device 3 (step S60). The user terminal device 3 displays the presented consideration corresponding to the user ID (step S61) and terminates the processing operation illustrated in FIG. 16.

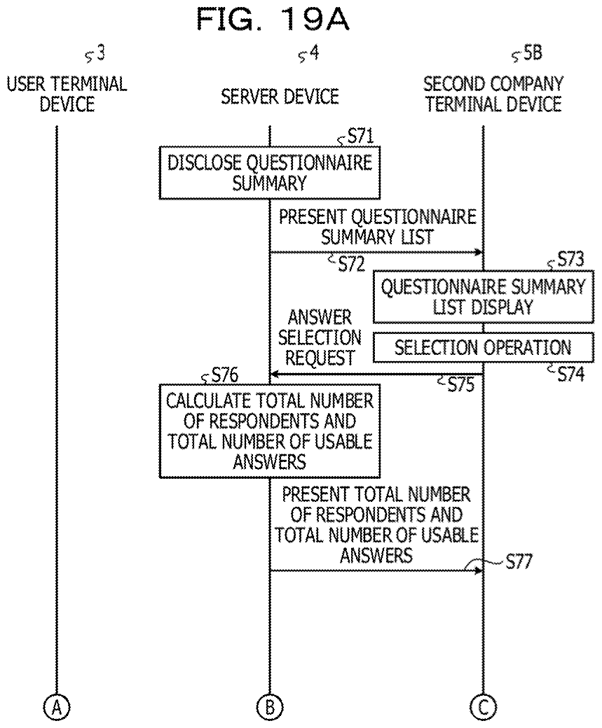

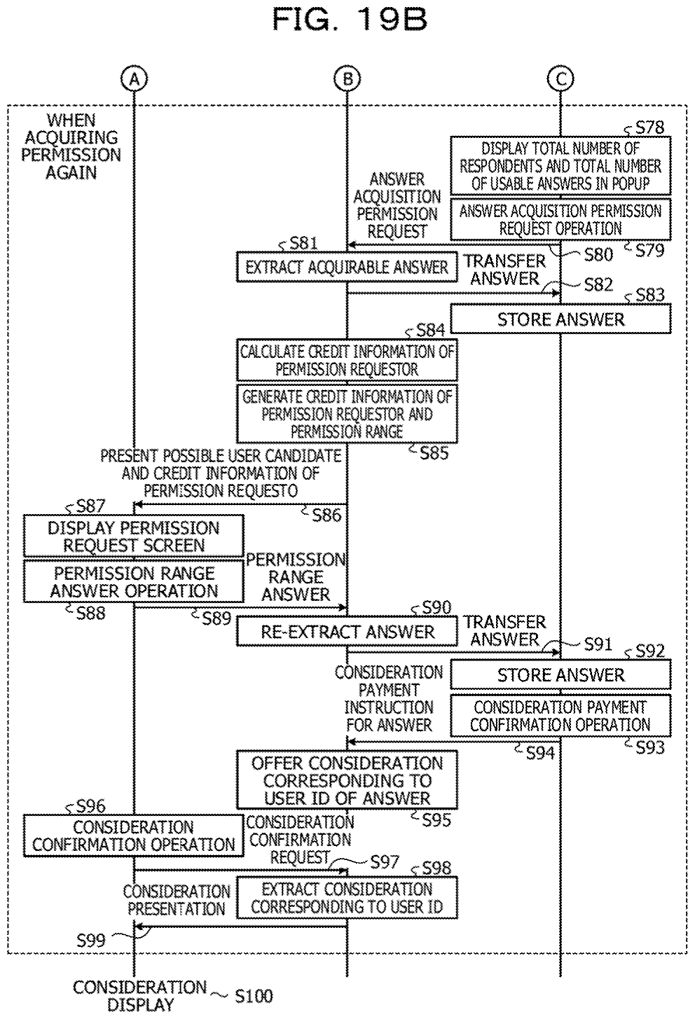

FIGS. 19A and 196 are sequence diagrams illustrating an example of processing operations of the user terminal device 3, the server device 4, and the second company terminal device 5B regarding second answer request processing. The server device 4 discloses a questionnaire summary (step S71). The server device 4 presents a list of questionnaire summaries to the second company terminal device 5B (step S72). The second company terminal device 5B displays a list screen for the questionnaire summaries (step S73). When detecting the selection operation during display of the questionnaire summary list screen (step S74), the second company terminal device 5B transmits an answer selection request of the selected questionnaire to the server device 4 (step S75).

In a case of detecting the answer selection request, the server device 4 calculates the total number of answer respondents and the total number of permitted usable answers (step S76), Note that the server device 4 calculates the total number of answer respondents from the answer DB 55, and the total number of permitted usable answers to the total number of answer respondents. The server device 4 presents the total number of answer respondents and the total number of permitted usable answers to the second company terminal device 5B (step S77). The second company terminal device 5B displays the total number of respondents and the total number of usable answers in a popup (step S78) and detects an answer permission request operation (step S79).

In a case of detecting the answer permission request, the second company terminal device 5B transmits a permission request for an acquirable answer to the server device 4 (step S80). In a case of detecting the permission request for an acquirable answer, the server device 4 extracts the acquirable answer from the answer DB 55 (step S81).

The server device 4 transfers the answer extracted from the answer DB 55 to the second company terminal device 5B (step S82). The second company terminal device 5B stores the transferred answer (step S83). Note that, although not illustrated, in a case of detecting a confirmation operation for a consideration payment instruction for the answer, the second company terminal device 5B transmits the consideration payment instruction for the answer to the server device 4. In a case of detecting the consideration payment instruction, the server device 4 offers the consideration corresponding to the user ID of the answer in the personal DB 51.

Furthermore, after transferring the answer to the second company terminal device 5B in step S82, the server device 4 calculates the credit information (step S84). The server device 4 generates the credit information of the answer permission requestor and the possible user candidate (step S85), and presents the credit information of the permission requestor and the possible user candidate to the user terminal device 3 (step S86).

After the credit information of the permission requestor and the possible user candidate are presented, the user terminal device 3 displays the permission request screen including the credit information of the permission requestor and the possible user candidate (step S87). After displaying the permission request screen, the user terminal device 3 detects an answer operation in a permission range for specifying a company or the consortium 2 to be permitted for use (step S88).

In a case of detecting the answer operation in the permission range, the user terminal device 3 transmits the permission range to the server device 4 (step S89). In a case of detecting the permission range, the server device 4 re-extracts a questionnaire answer and the permission range from the answer DB 55 (step S90). The server device 4 transfers the answer extracted from the answer DB 55 to the second company terminal device 5B (step S91). The second company terminal device 5B stores the transferred answer (step S92).

In a case of detecting a confirmation operation for a consideration payment instruction for the answer (step S93), the second company terminal device 5B transmits the consideration payment instruction for the answer to the server device 4 (step S94). In a case of detecting the consideration payment instruction, the server device 4 offers and updates the consideration corresponding to the user ID of the answer in the personal DB 51 (step S95). In a case of detecting a consideration confirmation operation (step S96), the user terminal device 3 transmits a consideration confirmation request to the server device 4 (step S97). In a case of detecting the consideration confirmation request, the server device 4 extracts a consideration corresponding to the user ID of the confirmation request from the personal DB 51 (step S98). The server device 4 presents the extracted consideration corresponding to the user ID to the user terminal device 3 (step S99). The user terminal device 3 displays the presented consideration corresponding to the user ID (step S100) and terminates the processing operation illustrated in FIGS. 19A and 19B.

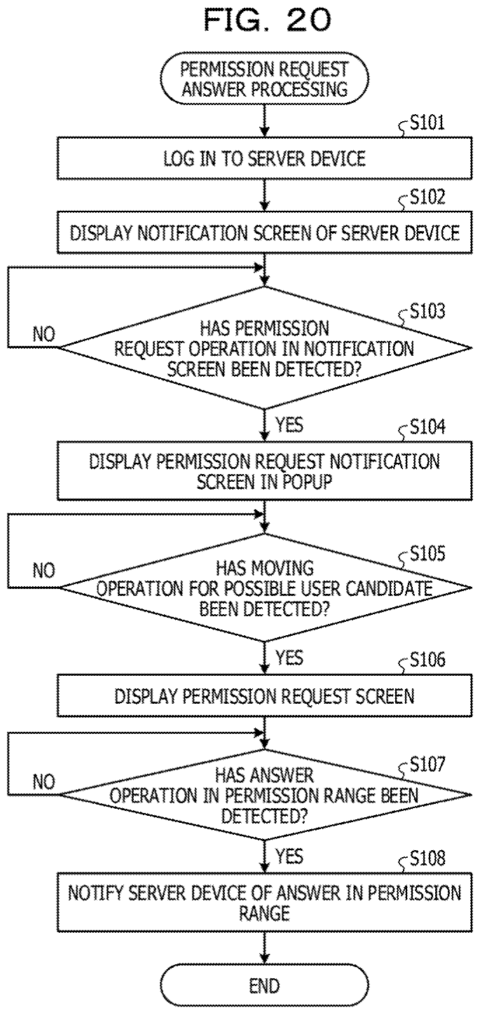

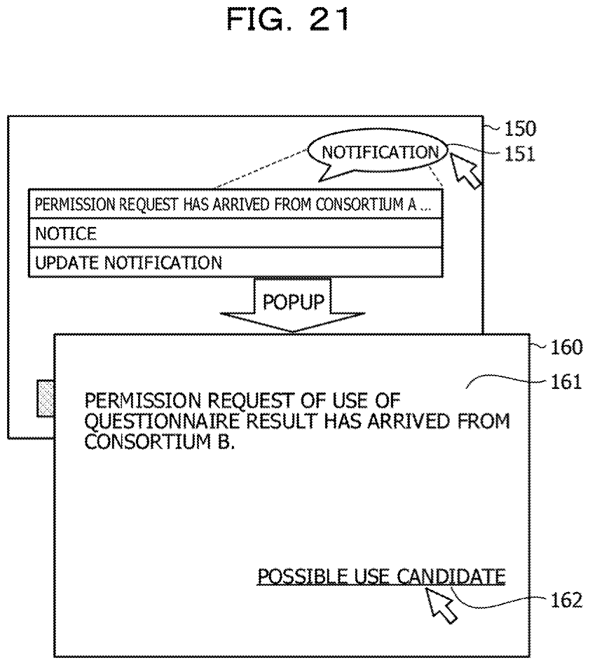

FIG. 20 is a flowchart illustrating an example of a processing operation of the user terminal device 3 regarding permission request answering processing; In FIG. 20, in a case of detecting a login to the server device 4 (step S101), the user terminal device 3 displays the notification screen 150 of the server device 4 (step S102), FIG. 21 is an explanatory diagram illustrating an example of the notification screen 150 and the permission request notification screen 160 of the user terminal device 3. The notification screen 150 includes notification content 151. The user terminal device 3 determines whether or not having detected a permission request operation for the notification content 151 in the notification screen 150 (step S103).

In a case of detecting the permission request operation (step S103, Yes), the user terminal device 3 displays the permission request notification screen 160 in a popup (step S104). Note that the permission request notification screen 160 includes permission requestor information 161 and a possible user candidate 162. The permission requestor information 161 is information for identifying the consortium 2 or the like that is a requestor of the permission request. The possible user candidate 162 moves the screen to the permission request screen 120 in response to the permission request operation. After displaying the permission request notification screen 160 in a popup, the user terminal device 3 determines whether or not having detected an operation for the possible user candidate 162 (step S105).

In a case of detecting the operation on the possible user candidate 162 (step S105, Yes), the user terminal device 3 displays the permission request screen 120 including the possible user candidate and the credit information of the possible user (step S106). After displaying the permission request screen 120, the user terminal device 3 determines whether or not having detected the answer operation in the permission range (step S107) Note that the answer operation in the permission range is, for example, an operation for specifying the all permission checkbox 121, the specified permission checkbox 122, or the requestor company permission checkbox 123. In a case of detecting the answer operation in the permission range (step S107, Yes), the user terminal device 3 notifies the server device 4 of the answer in the permission range (step S108) and terminates the processing operation illustrated in FIG. 20.

In a case of having not detected the permission request operation (step S103, No), the user terminal device 3 moves onto step S103 to determine whether or not having detected the permission request operation. Furthermore, in a case of having not detected the operation on the possible user candidate 162 (step S105, No), the user terminal device 3 moves onto step S105 to determine whether or not having detected the operation on the possible user candidate 162. In a case of having not detected the answer operation in the permission range (step S107, No), the user terminal device 3 moves onto step S107 to determine whether or not having detected the answer operation in the permission range.

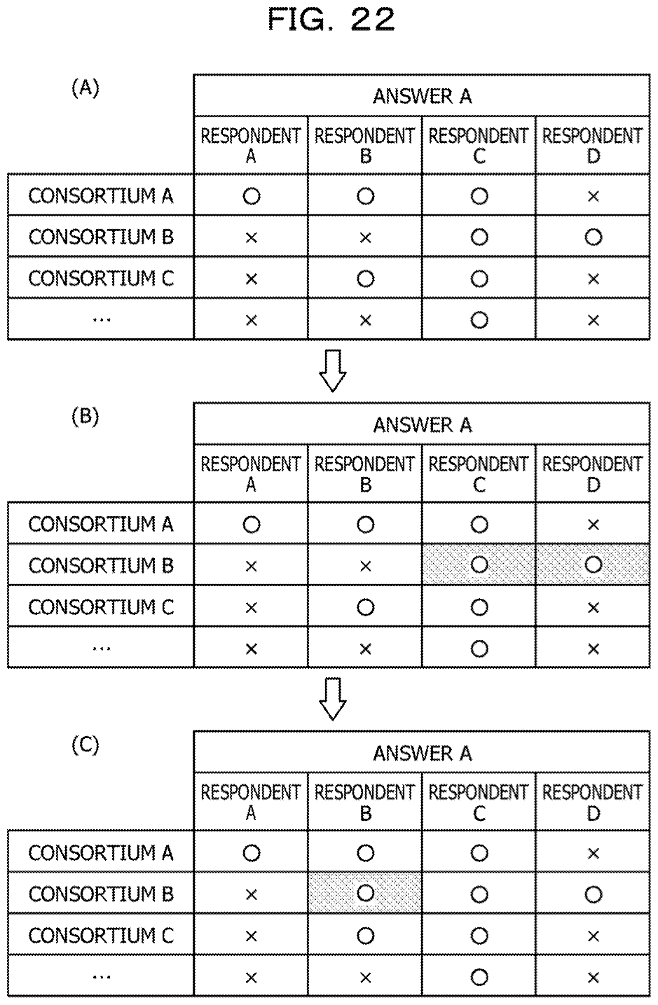

FIG. 22 is an explanatory diagram illustrating an example of change transition of permission for each respondent. In the state of (A) in FIG. 22, a permission status of an answer A to a questionnaire by a respondent A is a state where a consortium A is permitted (o), and consortia B and C are not permitted (x). Furthermore, the permission status of the answer A by a respondent B is a state where the consortia A and C are permitted (o) and the consortium B is not permitted (x). Moreover, the permission status of the answer A to the questionnaire by a respondent C is a state where consortia A, B, and C are permitted (o), and the permission status of the answer A by a respondent D is a state where the consortium B is permitted (o) and consortia A and C are not permitted (x).

In the case where an answer B by the respondent B is not permitted to the consortium B (x), as illustrated in the state of (B) in FIG. 22, the server device 4 is not able to use the answer B to the second company terminal device 5B in the consortium B.

To cope with the situation, the server device 4 requests the user terminal device 3 of the respondent B to permit use of the answer B by the respondent B from the second company terminal device 5B in the consortium B. Then, in a case where the user terminal device 3 of the respondent B has permitted the consortium B to use the answer B, the server device 4 sets the permission status of the answer B for the consortium B to permission (o), as illustrated in (C) in FIG. 22. As a result, the user of the second company terminal device 5B in the consortium B can use the answer B of the respondent B.

When requesting an answer to a question, the server device 4 according to the present embodiment presents the use consideration from the user who uses the answer and the credit information of the user to the user terminal device 3 as the respondent. In a case where the user is specified as a user who is permitted to use the answer by the user terminal device 3 as the respondent, the server device 4 stores the user ID of the user for each answer. In a case where use of the answer is requested by the user terminal device 3, the server device 4 determines whether or not the user ID of the user of the answer requested to use is in the answer DB 55. In a case where the user ID of the user of the answer requested to use is in the answer DB 55, the server device 4 provides the answer to the second company terminal device 5B as the user of the answer requested to use. Moreover, in the case where the user ID of the user of the answer requested to use is in the answer DB 55, the server device 4 offers a use consideration for the answer to the respondent of the answer requested to use. As a result, for example, a third party (company) who has obtained permission to use the answer from the respondent can significantly reduce the cost of re-conducting a questionnaire and the burden of searching for the respondent. Moreover, the respondent can save the labor of answering a questionnaire having the same gist, and can obtain a new consideration by permitting use of the answer. The company that has conducted the questionnaire can share the answer with the third party within the range permitted by the respondent. That is, the burden of obtaining the answer o the questionnaire can be reduced.

In a case where use of an answer is requested by the second company terminal device SB as a user who is not permitted to use the answer, the server device 4 presents the credit information and the use consideration to the user terminal device 3 as the respondent. As a result, the respondent can recognize the use request from the user who is permitted to use the answer.

Note that, for convenience of description, the use consideration has been exemplified by points. However, for example, electronic money, a token, a coupon, special information, or the like may be adopted and can be appropriately changed. Furthermore, the requestor company permission checkbox 123, the specified permission checkbox 122, and the all permission checkbox 121 have been exemplified on the permission request screen 120. However, answer use permission may be given on a company basis and may be appropriately changed.

The case in which the respondent permits the user to use an answer has been exemplified. However, expiration date may be provided for the use permission and can be appropriately changed.

In the answer sharing system 1, the case in which companies participating in the consortium 2 are targeted has been exemplified. However, a company not participating in the consortium 2 may be targeted, and the terminal device of the company may be made accessible to the server device 4 to share an answer with the company not participating in the consortium 2, and such a configuration may be appropriately changed.

Furthermore, each of the constituent elements of the units illustrated in the drawings does not always need to be physically configured as illustrated in the drawings. In other words, for example, specific forms of separation and integration of the respective units are not limited to the illustrated forms, and all or some of the units may be functionally or physically separated and integrated in an arbitrary unit according to various loads, use situations, and the like.

Moreover, all or arbitrary some of various processing functions executed in the respective devices may be executed by a central processing unit (CPU) (or a microcomputer such as a micro processing unit (MPU) or a micro controller unit (MCU)). Alternatively, all or arbitrary some of the various processing functions may of course be executed by a program analyzed and executed by a CPU (or a microcomputer such as an MPU or an MCU) or hardware using wired logic.

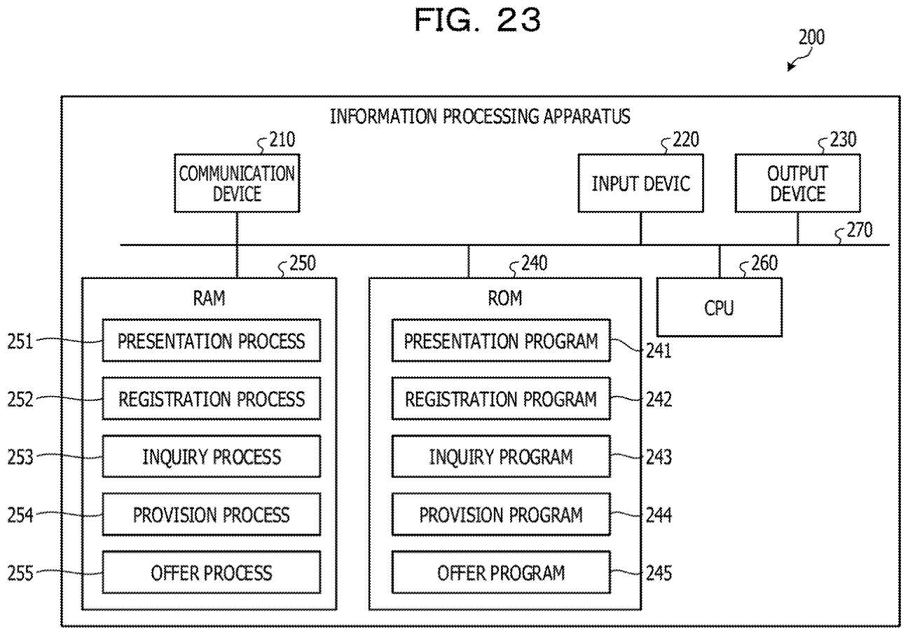

By the way, the various types of processing described in the present embodiment can be implemented by executing a program prepared in advance by an information processing apparatus. Therefore, hereinafter, an example of a terminal device 100 that executes a program having functions similar to those of the above-described embodiment will be described. FIG. 23 is an explanatory diagram illustrating an example of an information processing apparatus that executes an information processing program.

An information processing apparatus 200 that executes an information processing program illustrated in FIG. 23 includes a communication device 210, an input device 220, an output device 230, a ROM 240, a RAM 250, a CPU 260, and a bus 270. The communication device 210 communicates terminal device (not illustrated).

Then, the ROM 240 stores in advance an information processing program for exhibiting functions similar to those of the above-described embodiment. Note that the information processing program may be recorded on a recording medium readable by a drive (not illustrated) instead of the ROM 240. Furthermore, a recording medium may be, for example, a portable recording medium such as a compact disk read only memory (CD-ROM), a digital versatile disc (DVD) disk, a universal serial bus (USB) memory, or a secure digital (SD) card, a semiconductor memory such as a flash memory, or the like. The information processing program includes a presentation program 241, a registration program 242, an inquiry program 243, a provision program 244, and an offer program 245, as illustrated in FIG. 23. Note that the programs 241 to 245 may be integrated or distributed as appropriate.

Then, the CPU 260 reads out these programs 241 to 245 from the ROM 240, and expands each of these readout programs on a work area of the RAM 250. Then, as illustrated in FIG. 23, the CPU 260 causes each of the programs 241 to 245 expanded on the RAM 250 to function as a presentation process 251, a registration process 252, an inquiry process 253, a provision process 254, and an offer process 255.

When requesting an answer to a question, the CPU 260 presents the use consideration from the user who uses the answer and the credit information of the user to the terminal device as the respondent. In a case where the user is specified as the user who is permitted to use the answer from the terminal device as the respondent, the CPU 260 stores the identification information for identifying the user for each answer in the RAM 250. In a case where use of the answer is requested by the terminal device as the user, the CPU 260 determines whether or not the identification information of the user of the answer requested to use is in the RAM 250. In a case where the identification information of the user of the answer requested to use is in the RAM 250, the CPU 260 provides the answer to the terminal device as the user of the answer requested to use. In the case where the identification information of the user of the answer requested to use is in the RAM 250, the CPU 260 offers a use consideration for the answer to the respondent of the answer requested to use. As a result, the burden of obtaining an answer can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor included in an information processing apparatus to execute a process, the process comprising:
storing answer information that is information regarding an answer to a question, and identification information for identifying a user who is permitted to use the answer information;
in a case where use of the answer information is requested, determining whether or not identification information of a user who is a requestor is stored; and
in a case where the identification information of the user who is the requestor is stored, transmitting the answer information to the requestor.

2. The non-transitory computer-readable storage medium according to claim 1, the process further comprising:
storing use consideration information indicating a use consideration for a respondent as a provider of the answer information in a case where the user has used the answer information; and
in the case where the identification information of the user who is the requestor is stored, offering the use consideration to the respondent who is the provider of the answer information on the basis of the use consideration information stored in association with the answer information and the identification information.

3. The non-transitory computer-readable storage medium according to claim 2, the process further comprising:
notifying a terminal device as the respondent who is the provider of the answer information of credit information of the user who uses the answer information, and the use consideration information indicating the use consideration in the case where the user has used the answer information; and
in a case where use of the answer information by the user is permitted, storing the identification information in association with the answer information.

4. The non-transitory computer-readable storage medium according to claim 3, wherein
the terminal device as the respondent is notified of the credit information and the use consideration information in a case where use of the answer information is requested by a user who is not permitted to use the answer.

5. An information processing apparatus comprising:
a memory; and
circuitry coupled to the memory and configured to:
store answer information that is information regarding an answer to a question, and identification information for identifying a user who is permitted to use the answer information in the memory;
in a case where use of the answer information is requested, determine whether or not identification information of a user who is a requestor is stored; and
in a case where the identification information of the user who is the requestor is stored in the memory, transmit the answer information to the requestor.

6. The information processing apparatus according to claim 5, wherein the circuitry is configured to:
store use consideration information indicating a use consideration for a respondent as a provider of the answer information in the memory in a case where the user has used the answer information; and
in the case where the identification information of the user who is the requestor is stored, offer the use consideration to the respondent who is the provider of the answer information on the basis of the use consideration information stored in association with the answer information and the identification information.

7. The information processing apparatus according to claim 6, wherein the circuitry is configured to:
notify a terminal device as the respondent who is the provider of the answer information of credit information of the user who uses the answer information, and the use consideration information indicating the use consideration in the case where the user has used the answer information; and
in a case where use of the answer information by the user is permitted, store the identification information in association with the answer information in the memory.

8. The information processing apparatus according to claim 7, wherein
the terminal device as the respondent is notified of the credit information and the use consideration information in a case where use of the answer information is requested by a user who is not permitted to use the answer.

9. An information processing method comprising:
storing answer information that is information regarding an answer to a question, and identification information for identifying a user who is permitted to use the answer information;
in a case where use of the answer information is requested, determining whether or not identification information of a user who is a requestor is stored; and
in a case where the identification information of the user who is the requestor is stored in the memory, transmitting the answer information to the requestor.

10. The information processing method according to claim 9, further comprising
storing use consideration information indicating a use consideration for a respondent as a provider of the answer information in a case where the user has used the answer information; and
in the case where the identification information of the user who is the requestor is stored, offering the use consideration to the respondent who is the provider of the answer information on the basis of the use consideration information stored in association with the answer information and the identification information.

11. The information processing method according to claim 10, further comprising
notifying a terminal device as the respondent who is the provider of the answer information of credit information of the user who uses the answer information, and the use consideration information indicating the use consideration in the case where the user has used the answer information; and
in a case where use of the answer information by the user is permitted, storing the identification information in association with the answer information.

12. The information processing method according to claim 11, wherein
the terminal device as the respondent is notified of the credit information and the use consideration information in a case where use of the answer information is requested by a user who is not permitted to use the answer.
